(19) United States
(12) Patent Application Publication
(10) Pub. No.: US 2005/0253111 A1
(43) Pub. Date: Nov. 17, 2005

(54) Dual frequency nematic liquid crystal display

(76) Inventors: Venkat Naga Raja, Bangalore (IN); By Sujatha, Karnataka (IN); Subbarao Krishna Rao Prasad, Bangalore (IN); Shivaramakrishna Chandrashekhar, Bangalore (IN); Ila Chandrasekhar, Karnataka (IN); Channabasaveshwar Veerappa Yelamaggad, Bangalore (IN); Uma Siddhalingayya Hiremath, Bangalore (IN)

Correspondence Address: Dinesh Agarwal;Law Office, Suite 330, 5350 Shawnee Road, Alexandria, VA, 22312, US

(21) Appl. No.: 10/498,543

(22) PCT Filed: Dec. 14, 2001
(86) PCT No.: PCT/IN01/00220

§ 371 Date: Jun. 28, 2005

(30) Foreign Application Priority Data
Dec. 14, 2001 (IN) 126/MAS/2000

(51) Int. Cl. C09K 19/52; G02F 1/133

(52) U.S. Cl. 252/299.01; 349/36

(57) ABSTRACT

The liquid Crystal Device which comprises (a) pair of transparent substrates held facing each other with a gap normally employed such devices, (b) each substrate having on one of its surfaces a coating of a transparent electrically conducting material which serves as an electrode, (c) an additional layer of a coating of a polymer on the resulting substrate, (d) a dual frequency addrerssable nematic liquid crystal being filled in the gap between the coated surfaces of the substrates thereby forming a cell, and (e) the cell incorporated between a pair of crossed polarisers. The above device has the following advantages over the conventional TN-liquid crystal display: (i) a wider and symmetric viewing angle, and (ii) a much faster response time and (iii) improved multiplexibility

This invention pertains to an improved Liquid Crystal Display (LCD) Device. More particularly the invention pertains to a dual-frequency addressed rubbing-free twisted nematic liquid crystal display device. The LCD industry is a multi-billion dollar industry with products ranging from simple watch displays to flat panel colour TV screens. At present, devices based on nematic liquid crystals (like the twisted-nematic (TN) device and its modification the super-twisted nematic (STN) device) dominate the world LCD market. The device described in the present invention has certain distinct advantages over the conventional TN device. The most important of these are (i) a much faster response time (about one to two orders faster) and (ii) a wider and more symmetric viewing angle than the usual TN device.

Nearly all commercial LCDs make use of nematic liquid crystals of rod-like molecules. (This particular invention does not relate to liquid crystals of disc-shaped molecules, or discotic liquid crystals). The TN device consists of two parallel glass plates, separated from each other by means of spacers. The inner surfaces of the glass plates are coated with a thin layer of transparent electrically conducting material such as indium tin oxide, with an additional coating of a thin layer of polyimide. Macroscopic orientation of the liquid crystal director (or the preferred axis of orientation of the rod-like molecules) is achieved by prior unidirectional rubbing of the polymide with cotton cloth or the like. The rubbing directions are orthogonal for the two plates. The cell is then filled with a nematic liquid crystal Owing to the boundary conditions, the director is oriented along the rubbed direction on each glass plate, and hence the director undergoes a twist of 90° on going from one plate to the other. Polarizer sheets are attached to the outer surfaces of the glass plates. The axis of vibration (or polarizing axis) of each polarizer sheet is parallel to the director axis at the plate to which it is attached. Unpolarized light is transformed into linearly polarized light by the polarizer fixed on the entrance side of the cell and emerges on the exit side with the polarization axis rotated through 90°. The emergent light is transmitted by the second polarizer. Thus, in this configuration, the so-called “normally white mode”, the display appears bright in the OFF state. The application of an electric field normal to the nematic film orients the liquid crystal molecules (of positive dielectric anisotropy, ε_{∥-ε}_{⊥}=Δε>0) with the director along the direction of the applied field. In this ON state, the state of polarization of the incident light is not rotated by the liquid crystalline medium and the display appears dark. Keeping one polarizer parallel to and the second polarizer perpendicular to the rubbing direction results in a black appearance in the OFF state and bright appearance in the ON state. This is the so-called “normally black mode”.

A non-contact alignment technique has been developed recently by exposing the polyimide coating to polarized UV radiation. This photoalignment technique may also be used instead of the rubbing method.

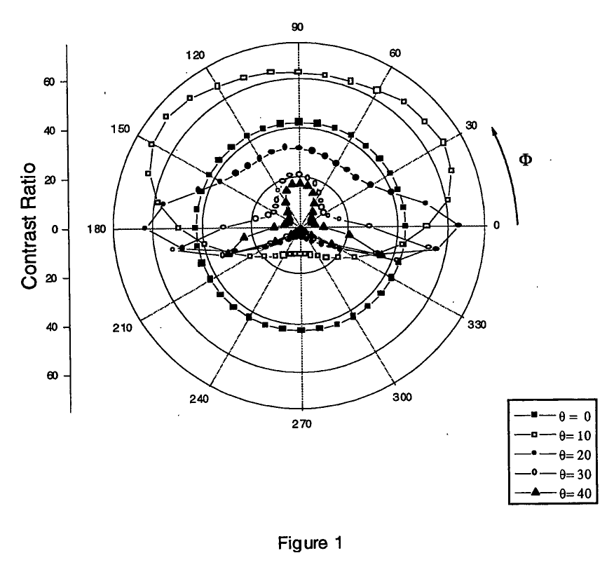

A disadvantage with the above TN device is that when it is viewed obliquely, there is a marked loss of contrast between the ON and OFF states and even contrast inversion at higher angle along the vertical direction. FIG. 1 of the drawing accompanying this specification shows a typical polar plot of the contrast ratio for a conventional TN device. Here, θ and φ are referred to as the polar angle and the azimuthal angle respectively. The axes of the polarizer and analyser are normal to each other. The contrast ratio is highly asymmetric along the vertical axis.

Many methods have been proposed to improve the viewing angle, such as the use of an external retardation film [H. Mori, Jpn. J. Appl. Phys., 36, 1068-1072 (1997); H. Mori, Yoji Itoh, Yosuke Nishiura, Taku Nakamura, Yukio Shiinaganea, Jpn. J. Appl. Phys., 36, 143-147 (1997); H. Ong, Mol. Ctyst. Liq. Ctyst., 320, 59-67 (1998)], a compensating LC layer [E. Wiener-Avnear, “Twisted nematic liquid crystal light valve with birefringence compensation”, U.S. Pat. No. 4,408,839 (Oct. 11, 1983); E. Wiener-Avnear and J. Grinberg, U.S. Pat. No. 4,466,702 (1984); I. Kobayashi, U. Mitsuhiro, U. Ishihara, S. Yokoyama, K. Adachi, K. Fujimoto, H. Taneka, Y. Miyatake and S. Hotta, SID 1989, Digest of Technical Papers, P-114 (1989)], new operational modes like the multidomain, including the vertical alignment, mode [K. H. Yang, Jpn. J. Appl. Phys., 31, L1603-1605 (1992) and J. Chen, P. J. Bos, D. R. Bryant, D. L. Johnson, S. H. Jamal, J. P. Kelly, SID 95, Digest, 865-868 (1995)], the bend-alignment mode [P. J. Bos and K. R. Kochler/Beran, Mol. Cryst. Liq. Cryst., 113, 329-339 (1984)], the in-plane switching mode [G. Baur, R. Kiefer, H. Klausmann and F. Windseheid, Liquid Crystal Today, 5, 13-14 (1995); M-Oh-e, M. Yoneya and K. Kondo, J. Appl. Phys., 82, 528-535 (1997); S. H. Lu, H. Y. Kim, I. C. Park, B. G. Rho, J. S. Park, H. S. Park and C. H. Lu, Appl. Phys. Lett., 71, 2851-2853 (1997)] and the amorphous TN-LCD mode [Y. Toko, T. Sugiyama, K. Katoh, Y. Iimura and S. Kobayashi SID 93 Digest, 622-625 (1993); J. Appl. Phys., 74, 2071-75 (1993); K. Katoh and S. Kobayashi, Display Devices, 26-28 (1993)].

Of these, the so-called amorphous TN-LCD is worthy of note as it involves a relatively simple fabrication process and has a wide and symmetric viewing angle. The liquid crystal material used is a nematic doped with a chiral-molecule, the concentration of the dopant being adjusted to give a 90° twist of the director in the cell. A polymer film is coated on the transparent conducting substrates but no rubbing is done. The non-rubbed polymer film is optically isotropic. Thus in the OFF state the nematic director is parallel to the surface of each substrate, but randomly oriented in the plane of the substrate. In the ON state, the director is normal to the substrates. This device gives an improved viewing angle characteristic and is free from contrast inversion.

Furthermore, it can be pointed out that the traditional TN-LCDs have been fabricated by using mechanical rubbing of the polyimide layer to align LC molecules, but this technique generates dust and electrostatic charges. This is a very serious drawback as it will sometime destroy thin-film transistors (TFTs) for active matrix driven TN-LCDs. It is very essential then to adopt rubbing free technologies in order to improve the production yield and make the fabrication process simple and cost effective.

Another major disadvantage with the conventional TN device is that its electrooptic response is rather slow. Typically, with a cell gap of about 8 μm, the switch-off time, τ_{OFF} (i.e. the time required to attain 90% transmission starting from the dark state) is about 30 ms. This is a serious drawback especially when one wants to use the device for rapidly addressed multiplexed displays.

Further, the present day colour TFT-LCDs run in TN mode. One of the key feature TFT-LCDs should possess is the high speed response time suitable for the motion video for it to cut into the giant CRT market.

Therefore, there is a necessity to develop a new simple matrix LCD with a very fast response time.

The main object of the present invention is to provide a rubbing free device which has a much faster response, and at the same time has a wide and symmetric viewing angle.

The present invention describes a dual-frequency addressable amorphous TN-LCD. It is well established that the response time of the dual-frequency addressed TN display is much faster than the conventional (single frequency) TN-LCD [M. Schadt, Mol. Cryst. Liq. Cryst., 89, 77-92 (1982); I. C. Koo and S. T. Wu, “Optics and Nonlinear Optics of Liquid Crystals”, published by World Scientific Publishers Co., Singapore; W. Haase, “Side chain liquid crystal polymers”, Ch.11, Ed. By C. B. McArdle, Published by Chapman and Hall, New York; H. Kitzerow, Mol. Cryst. Liq. Cryst., 321, 457-472 (1998)]. In addition, it has been shown that in dual frequency addressed TN-LCDs the multiplexibility increases by a factor of more than 30 compared with the conventional addressing. [M. Schadt, Mol. Cryst. Liq. Cryst., 89, 77-92 (1982)]. In the present invention a dual frequency addressable nematic LC is used in an amorphous TN-LCD configuration. It then turns out that very fast response time as well as a wide viewing angle can be obtained.

The dual-frequency addressable nematic LC material used in the present invention has the following properties. In the nematic phase, the sign of the dielectric anisotropy (ΔF) depends on the frequency. For low frequencies, Δε is positive and the molecules align parallel to the direction of the applied field of sufficient strength. For high frequencies, Δε becomes negative and the molecules align perpendicular to the direction of the applied field. In other words, there is a cross-over frequency (f_{c}) at which Δε changes sign. Thus it is possible to align the molecules either parallel or perpendicular to the field depending on whether f<f_{c} or f>f_{c} respectively. The device may use any material having these properties, as for example, pure compounds like the 4^{th}, 6^{th} and 8^{th} members of the homologous series 4-alkyloxybenzoyloxy-4′-cyanoazobenzene (nOBCAB with n=4, 6 and 8) and the commercially available dielectric switching materials [ZLI-2461, M1 mixture (Merck), RO-TN-2851 (Roche), EK11650 (Eastman Kodak)].

The compound 6OBCAB exhibits the following sequence of transitions in the cooling mode 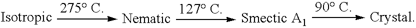
The cross-over frequency f_{c} is 200 kHz at 130° C., the temperature at which the performance of the device has been evaluated. We have, as another example used a commercially available dielectric switching material (2F-3333, Rolic) which exhibits a room temperature nematic phase, in the present experiments to demonstrate the principle of operation of the devices. This material is a multicomponent mixture using the four-ring ester 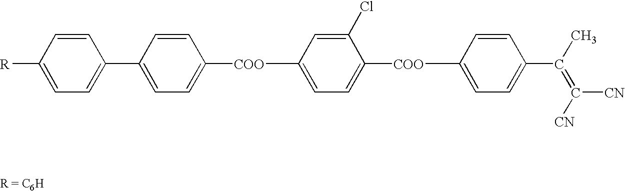
and pyridazine 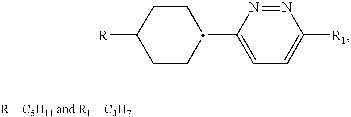
as the main components.

The material specifications are given below:

| | | |
|---|---|---|
| Clearing temperature | 68° | C. |
| Melting temperature | <10° | C. |
| ε_{⊥} | 9.4 | |
| Dielectric anisotropy, Δε (low frequency) | +4.1 | |
| Δε (high frequency) | −4.7 | |
| Cross over frequency f_{c} | 3.2 | kHz |
| Ordinary refractive index, nₒ. | ˜1.5 | |
| Optical anisotropy, Δn | ˜0.10 | |
| Viscosity (+22° C.) | 71 | mP |

According to the present invention there is a liquid crystal device which comprises
(a) pair of transparent substrates held together with a gap normally employed in such devices
b) the substrates having in one of its surfaces a coating of a transparent electrically conducting material which serves as an electrode
(c) an additional layer of a coating of a polymer on the resulting substrate
(d) a dual-frequency addressable nematic liquid crystal being filled in the gap between the coated surfaces of the substrates thereby forming a cell and
(e) the cell incorporated between a pair of crossed polarizers.

According to an embodiment of the invention transparent materials such as glass, plastic, or such other material may be used as a substrate.

According to another embodiment of the invention the resulting substrates are coated with silica for its use as a barrier layer to prevent the leaching of ions from the glass to the liquid crystal material

According to still another embodiment of the invention the resulting substrates incorporate regular pattern of red, green and blue colur filters corresponding to the pixel pattern of the colour matrix TN display.

According to still another embodiment of the invention electrically conducting material selected from Indium Tin Oxide, Tin Oxide is used.

According to still another embodiment of the invention the resulting substrates are coated with an additional layer of polymer selected from polyimides, polyamides etc. to be used as the alignment layer

According to yet another embodiment of the invention the substrates are spaced apart by employing spacers such as polyethyleneterephthalate films, polyimide films; glass microspheres etc.

According to an embodiment of the invention the dual frequency addressable nematic material such as the pure compounds like the 4^{th}, 6^{th} and 8^{th} members of the homologous series 4alkyloxybenzoyloxy-4′-cyanoazobenzene and commercially available dielectric swithching materials [ZLI 2461, MI Mixture (Merck), RO-TN 2851 (Roche), EK11650 (Eastman Kodak), mixture 2F-3333 (Rolic)] are employed.

According to still another embodiment of the invention an optical reflector may be provided at the bottom of the device for its use in a reflecting mode.

The device is fabricated as explained below. The surfaces of the glass plates were coated with transparent electrically conducting material, such as Indium Tin Oxide (ITO). An additional layer of polyimide was then coated on the ITO coated substrates. No rubbing was done. The coated surfaces of the two substrates are held facing each other with a gap of about 8 μm between them, defmed by means of non-conducting spacers. The gap is then filled with either the commercially available dual-frequency mixture 2F-3333 or with the pure compound 6OBCAB. In each case, the dielectric switching material is doped with the chiral dopant. The concentration of the chiral dopant is adjusted so as to be d/p=¼, where d and p stand for the cell thickness and the chiral pitch. This gives rise to a 90° twist of the director in the cell. The fabricated cell is positioned between crossed polarizers.

The invention is described in detail in the Examples given below which are meant only to illustrate the invention and therefore should not be construed to limit the scope of the present invention.

### EXAMPLE 1

The surfaces of the glass plates were coated with Indium Tin Oxide (ITO ), a transparent electrically conducting material. An additional layer of polyimide (Liquicoat ®PI ZLI-2650, Merck) is then coated on the ITO coated substrates. No rubbing was done. The coated surfaces of the two substrates are held facing each other with a gap of 8 μm between them, defined by means of non-conducting spacers. The gap is then filled with the commercially available dual-frequency nematic mixture (2F-3333, Rolic) which is doped with a chiral dopant (CM-9209F, Rolic). The concentration of the chiral dopant is adjusted to 0.2% by weight to give a 90° twist of the director in the cell. The mixture is filled into the cell in the isotropic phase. The thus fabricated cell is positioned between crossed polarizers.

### EXAMPLE 2

The surfaces of the glass plates were coated with Indium Tin Oxide (ITO), a transparent electrically conducting material. An additional layer of polyimide (Liquicoat ®PI ZLI-2650, Merck) is then coated on the ITO coated substrates. No rubbing was done. The coated surfaces of the two substrates are held facing each other with a gap of 8 μm between them, defined by means of non-conducting spacers. The gap is then filled with the dual frequency addressable compound 6OBCAB doped with a chiral compound, 4-[4(S-Methylheptyloxy)benzoyloxy]-4cyanoazobenzene, which exhibits the following sequence of transitions

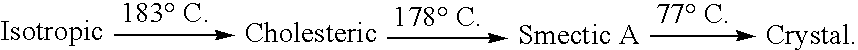

The concentration of the chiral dopant is adjusted to 1% by weight to give a 90° twist of the director in the cell. The mixture is into the cell in the nematic phase. The thus fabricated cell is positioned between crossed polarizers.

The two devices described in Examples 1 & 2 are utilised as the test devices. The results of the investigation carried out using the device 1 fabricated according to the Example 1 which is designated as Device 1 and using the device 2 fabricated according to the Example 2 which is designated as Device 2 are given below.

### Device 1

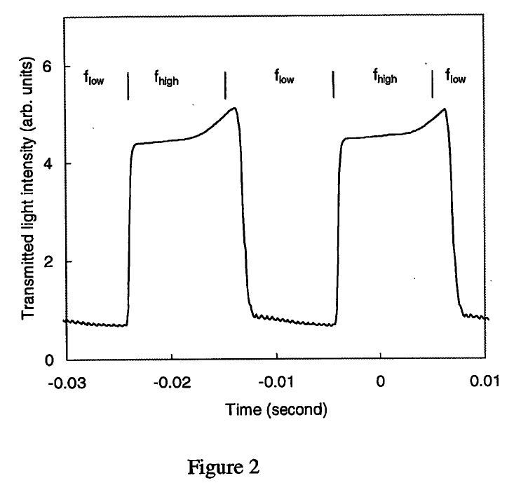

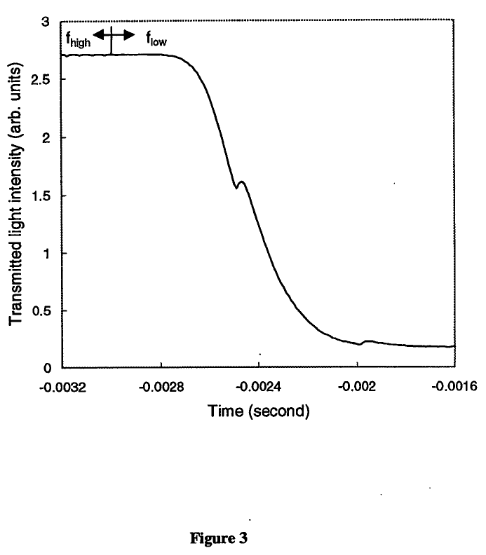

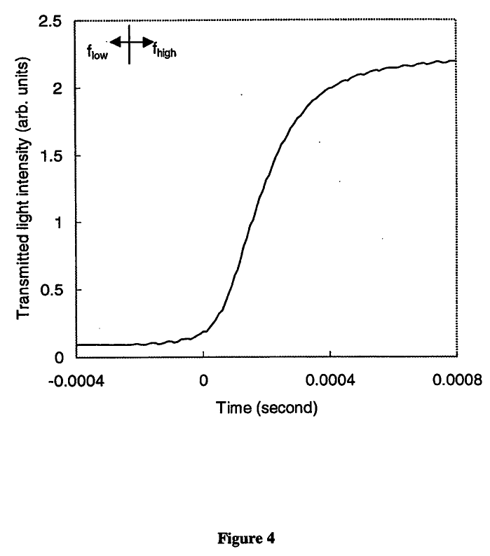

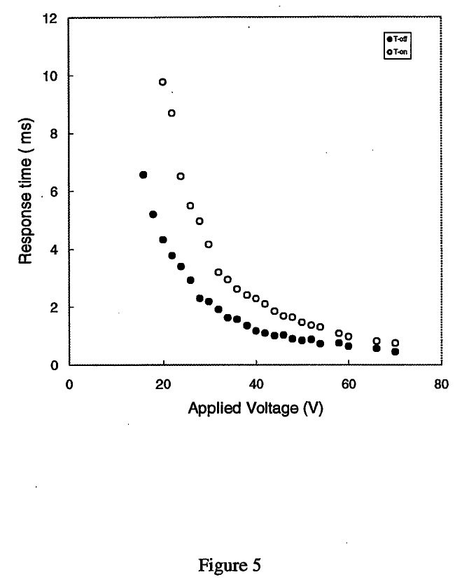

To study the electro-optic response time, an AC voltage of constant amplitude, either sine or square in shape was applied to the sample, and the frequency switched between f_{low}=1 kHz (Δε>0) and f_{high}=20 kHz (Δε<0). A typical electro-optic response curve obtained for the device is shown in FIG. 2. The regions marked “f_{low}” and “f_{high}” represent the time duration over which the frequency of the applied voltage (60 Vᵣₘₛ) was 1 kHz (f_{low}) and 20 kHz (f_{high}) respectively. If the operating frequency is changed from f_{high} to f_{low} the device switches from a bright state to a dark state. An enlarged view of the electro-optic response during this switching is shown in FIG. 3. The time required for this switching, τₒₙ (i.e. the time required to reach 10% of transmission from the bright state) is 1.2 ms. Switching the frequency from f_{low} to t_{high} leads to a change from a dark to a bright state and the corresponding electro-optic response curve is shown in FIG. 4. The time required for this switching τ_{off}, is 550 μs. As shown in FIG. 5, both τₒₙ and τ_{off} decrease with increasing voltage.

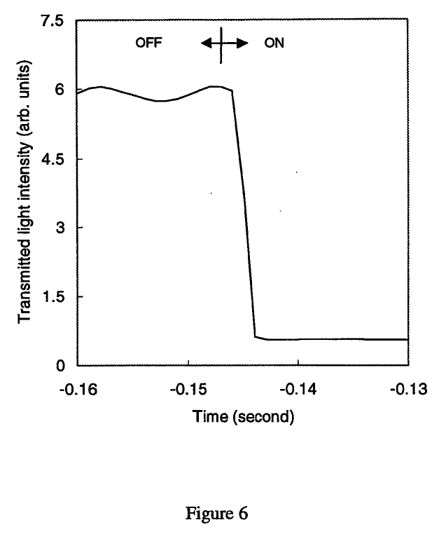

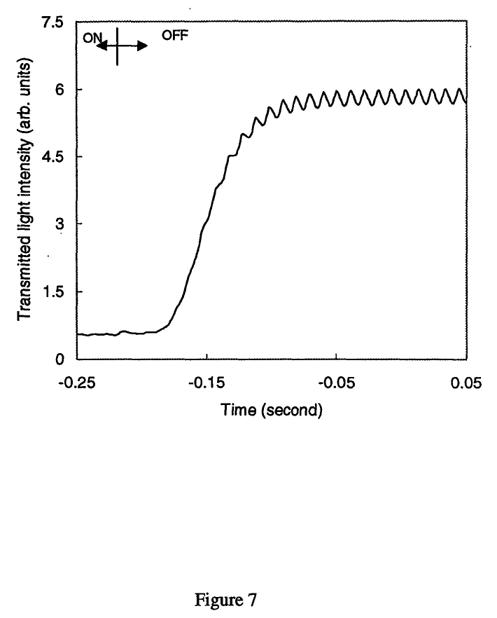

To estimate the improvement of this dual-frequency driving scheme over the conventional single frequency scheme, the performance of the TN-LCD device with the single frequency driving has been obtained. The electro-optic responses obtained in the ON and OFF states by driving the device with a voltage of 60 Vᵣₘₛ, 1 kHz sine wave pulse of 0.5 seconds duration with a repetition rate of 2 Hz are shown in FIGS. 6 and 7 respectively. The values of τₒₙ and τ_{off} extracted from these figures are 1.2 ms and 110 ms respectively. Thus the dual frequency addressing results in 200 times faster switch-off time as compared to the conventional single frequency addressing scheme.

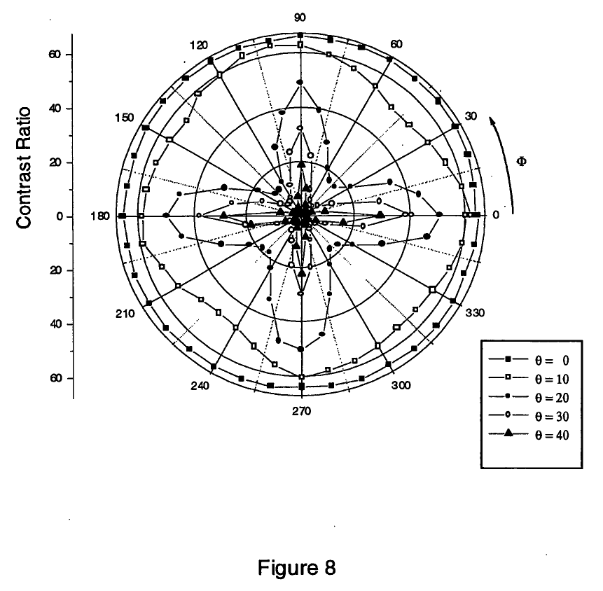

The polar plot of the contrast ratio between the intensities in the ON and OFF states for the device of the present invention is given in FIG. 8. The advantage of the device is clear from the fact that the curve for the contrast ratio is symmetric along the vertical and horizontal directions for a fixed value of θ. The decrease in the contrast ratio at oblique viewing angles midway between the axes of the polarizers does not arise from the optics of the LC material. It is due to the imperfect light blocking property of the crossed polarizers at oblique angles (see e.g., M. Oh-E, M. Yoneya, M. Ohta and K. Kondo, Liquid Crystals, 22, 391-400 (1997); H. Bock, Appl. Phys. Lett., 73,2905-2907 (1998)).

### Device 2

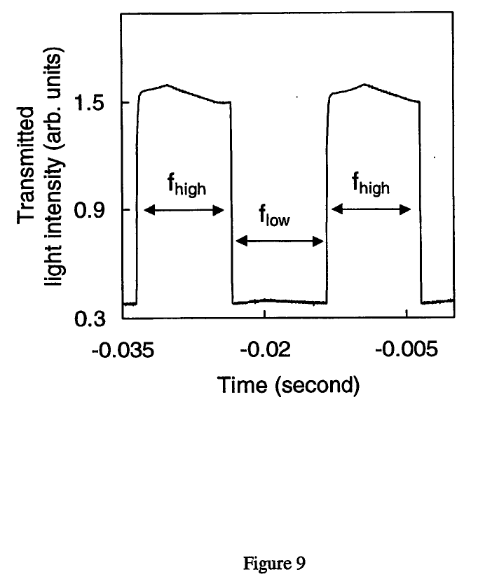

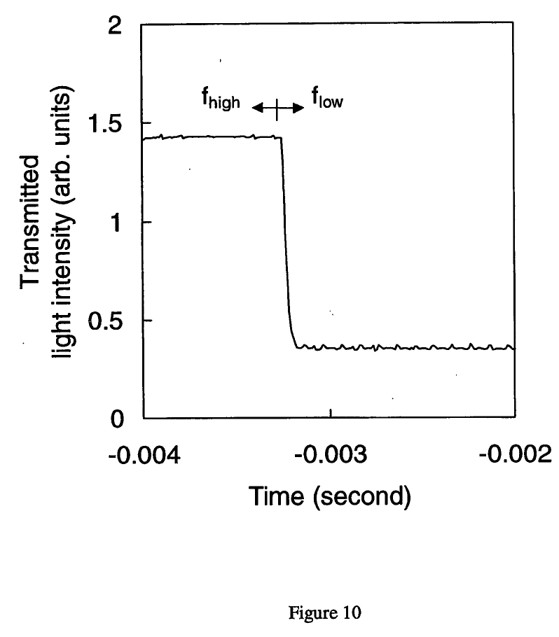

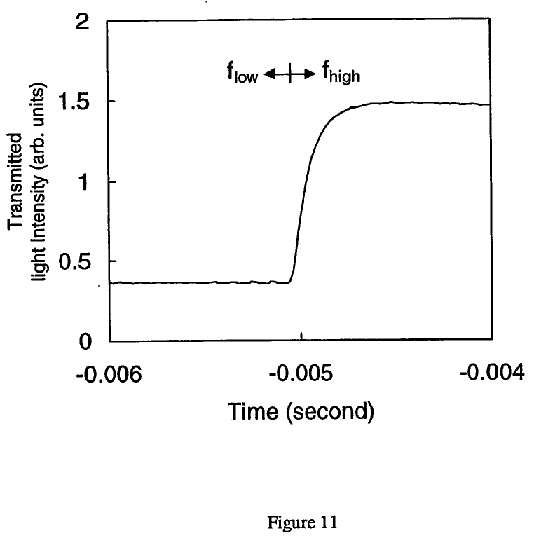

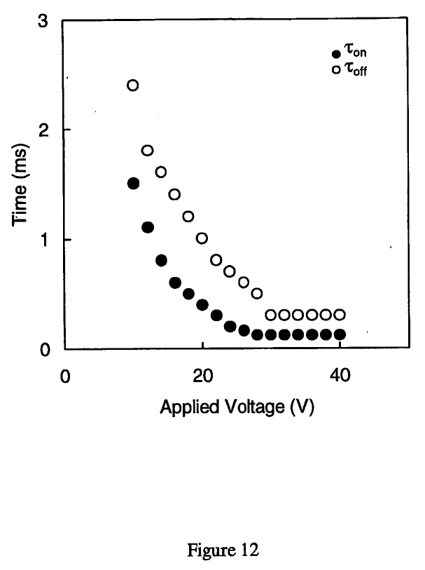

To study the electro-optic response time, an AC voltage of constant amplitude, either sine or square in shape was applied to the sample, and the frequency switched between f_{low}=10 kHz (Δε>0) and f_{high}=600 kHz (Δε<0). A typical electro-optic response curve obtained for the device is shown in FIG. 9. The regions marked “f_{low}” and “f_{high}” represent the time duration over which the frequency of the applied voltage (30 Vᵣₘₛ) was 10 kHz (f_{low}) and 600 kHz (f_{high}) respectively. If the operating frequency is changed from f_{high} to f_{low}, the device switches from a bright state to a dark state. An enlarged view of the electro-optic response during this switching is shown in FIG. 10. The time required for this switching, τₒₙ (i.e. the time required to reach 10% of transmission from the bright state) is 50 μs. Switching the frequency from f_{low} to f_{high} leads to a change from a dark to a bright state and the corresponding electro-optic response curve is shown in FIG. 11. The time required for this switching τ_{off}, is 300 μs. As shown in FIG. 12, both τₒₙ and τ_{off} decrease with increasing voltage.

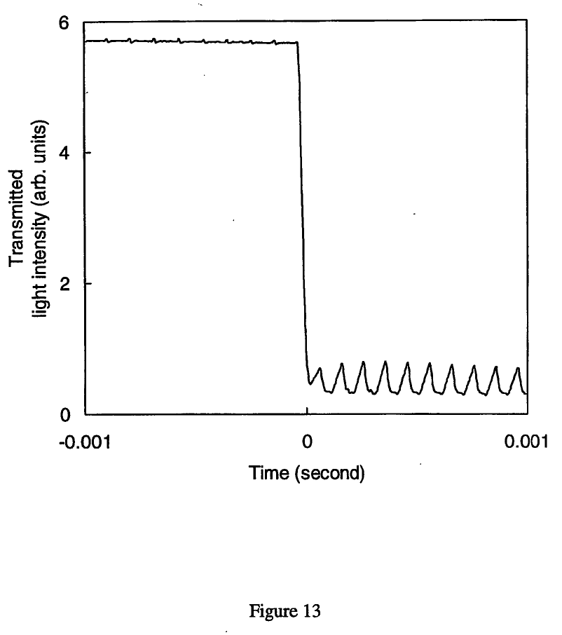

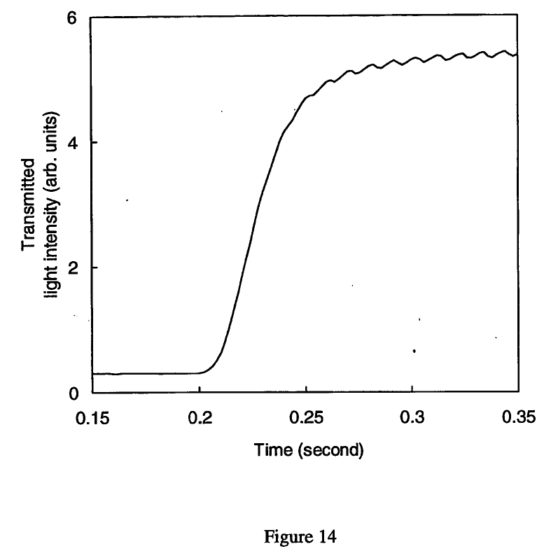

To estimate the improvement of this dual-frequency driving scheme over the conventional single frequency scheme, the performance of the TN-LCD device with the single frequency driving has been obtained. The electro-optic responses obtained in the ON and OFF states at the same temperature (130° C.) by driving the device with a voltage of amplitude 30 Vᵣₘₛ and frequency 10 kHz with a pulse duration of 0.5 seconds at a repetition rate of 0.5 s⁻¹ are shown in FIGS. 13 and 14 respectively. The values of τₒₙ and τ_{off} extracted from these figures are 50 μs and 60 ms respectively. Thus the dual frequency addressing results in 200 times faster switch-off time as compared to the conventional single frequency addressing scheme.

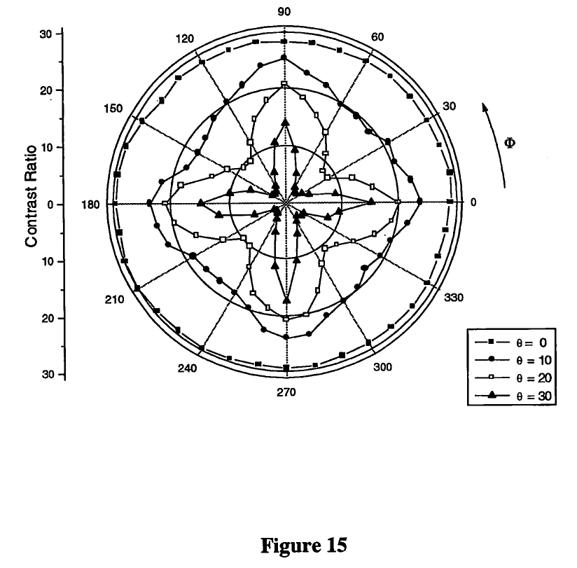

The polar plot of the contrast ratio between the intensities in the ON and OFF states for the device of the present invention is given in FIG. 15. The advantage of the device is clear from the fact that the curve for the contrast ratio is symmetric along the vertical and horizontal directions for a fixed value of θ. The decrease in the contrast ratio at oblique viewing angles midway between the axes of the polarizers does not arise from the optics of the LC material and as mentioned earlier, it is due to the imperfect light blocking property of the crossed polarizers at oblique angles.

Comparison of the Results and Inference:

From the investigations performed on the two test devices, it is clear that the dual frequency addressing results in 200 times faster switch-off time as compared to the single frequency addressing scheme. However, owing to the difference in the physical properties of the two nematic LC mixtures used in the device cell, there is the difference in the operating frequency and the voltage. Also, as the device 2 is operating at very high temperature (ie., 130° C.) has a faster response time compared to the room temperature operating device 1. On comparing FIGS. 8 and 15 with FIG. 1, it is evident that the viewing angle cone has widened and looks more symmetric with the technique adopted in the present invention. However, the contrast ratio for the device 2 is seen to be quite less compared to that of the the device 1 while the contrast ratio of the device 1 is almost the same as that observed for the conventional TN-LCD. The reason for this is that the nematic LC mixture is not filled into the device 2 in the isotropic phase, as the clearing temperature is very high (275° C.) while the device cell 1 is filled by the nematic LC mixture in the isotropic phase as its clearing temperature is quite low (68° C.). It is known that filling the LC in the nematic phase into the cell with the nonrubbed polyimide films results in a nonuniform LC molecular alignment mainly due to the flow alignment [Y. Toko, T. Sugiyama, K. Katoh, Y. Iimura and S. Kobayashi J. Appl. Phys., 74, 2071-75 (1993)].

### ADVANTAGES OF THE PRESENT INVENTION

The device has a very much faster response time (about 200 times faster) than the conventional TN-LCD device and hence can be made use for the fabrication of simple matrix TN-LCDs with fast response time.

The device has a much wider and more uniform viewing angle than the conventional TN-LCD. Hence the device is economical as no additional retarders or compoensators or complicated electrode patterns are needed to widen the viewing angle of the conventional TN-LCDs.

The device is not only easy to fabricate but also improves the yield as the mechanical rubbing of the polymer is avoided.

The device has high multiplexing capabilities because of the dual frequency addressing technique

1. A dual frequency dual amplitude addressed twisted nematic liquid crystal device with a wide and symmetric viewing angle, said device comprising of:
a) a pair of transparent substrate held facing each other with spacers to provide a gap between the substrates;
b) insulating layers of silica covering inner surfaces of said substrate to avoid leaching of ions from the substrates to the liquid crystal;
c) a layer of electrically conducting transparent material located on each of the said insulating layer, which serves as an electrode;
d) an additional un-rubbed polymeric layer located on each of the said electrode, which avoids dust particles and prevents the formation electrostatic charges;
e) a dual frequency addressable nematic liquid crystal doped with chiral compound in nematic phase is placed in the gap of coated surfaces of substrate to get a cell; and
f) a pair of polarizers placed on either side of the cell.

2. The device as claimed in claim 1, wherein the transparent substrate is selected from glass or plastic plates.

3. The device as claimed in claim 1, wherein the electrically conducting transparent material is selected from Indium Tin Oxide, Tin Oxide or any D conducting polymer.

4. The device as claimed in claim 1, wherein the polymeric layer is selected from polyimides and polyamides to form an alignment layer making the molecules lie flat against the plane of the substrate but with random orientation of the molecular long axes in the plane.

5. The device as claimed in claim 1, wherein the coated surfaces of the substrates are held facing each other with the gap of about 2-10 μm preferably 8 μm.

6. The device as claimed in claim 1, wherein the spacers are selected from polyethylene terephthalate films, polyimide films, glass microspheres or bars.

7. The device as claimed in claim 1, wherein the dual frequency addressable liquid crystal material has, in the nematic phase, the positive sign of the dielectric anisotropy (Δε) for low frequencies with the molecules aligning parallel to the direction of the applied field of sufficient strength and for high frequencies, Δε becomes negative and the molecules align perpendicular to the direction of the applied field.

8. The device as claimed in claim 1, wherein the dual frequency addressable nematic material is selected from 4^{th}, 6^{th} and 8^{th} members of the homologous series of 4-alkoxybenzoyloxy-4′-cyanoazobezene in pure from, commercially available ZLI 2461, M1 mixture (Merck), RO-TN 2851 (Roche), EK 11650 (Eastman Kodak) and a mixture of 2F-3333 (Rolic).

9. The device as claimed in claim 1, wherein the dual frequency addressable nematic material is doped with a chiral dopant, which is selected from CM-9209F (Rolic), CB-15 (Merck) and cholesterol esters.

10. The device as claimed in claim 1, wherein the concentration of the dopant is adjusted to give a 90° twist to the director in the cell.

11. The device as claimed in claim 1, wherein an optical reflector is provided optionally at the bottom of the device for its use in a reflecting mode.

12. The device as claimed in claim 1, wherein in dual amplitude mode the magnitudes of the voltages applied during low and high frequencies are variable.

13. The device as claimed in claim 1, wherein the high frequency is applied in a pulse mode for a short duration in the range of 1-10 m sec.

14. The device as claimed in claim 1, wherein said device having a wide and symmetric viewing angle in excess of ±40° polar angle.

15. The device as claimed in claim 1, wherein the electro-optic response time t_{off} of the device is in the range of 10 μs-20 ms.
